(19) United States
(12) Patent Application Publication
(10) Pub. No.: US 2005/0174215 A1
(43) Pub. Date: Aug. 11, 2005

(54) Portable, lightweight device for receiving pre-recorded messages at programmed times

(76) Inventor: William Peze, Colombes (FR)

Correspondence Address: Jackson Patent Law Office, Suite 100, 211 N Union Street, Alexandria, VA, 22314, US

(21) Appl. No.: 10/506,672

(22) PCT Filed: Mar. 19, 2003
(86) PCT No.: PCT/FR03/00873

(30) Foreign Application Priority Data
Mar. 20, 2002 (FR) 02/03857

(51) Int. Cl. G08B 1/00

(52) U.S. Cl. 340/309.16; 368/244; 368/10

(57) ABSTRACT

A portable recorder device comprising means for informing, relating to the reception of pre-recorded messages, on programmed days and at programmed times. The device comprises a recorder and an internal clock triggering delivery of messages at desired dates and times, characterized in that it comprises a housing having two faces, an A face comprising a press button (1) and a loudspeaker (2) enabling a person with a deficient memory to press on the press button (1) in order to hear what should be done when an alarm is sounded, and a B face which is only accessible by opening a shutter which covers it, a B face comprising a microphone (14), a screen (3) indicating the date and time, programmable by means of the displacement keys (4) and coded information (7) for, when the date and time is fixed, recording the message by pressing on a key (5), the internal clock of the device enabling the alarm to be sounded at the desired time in order to hear the message.

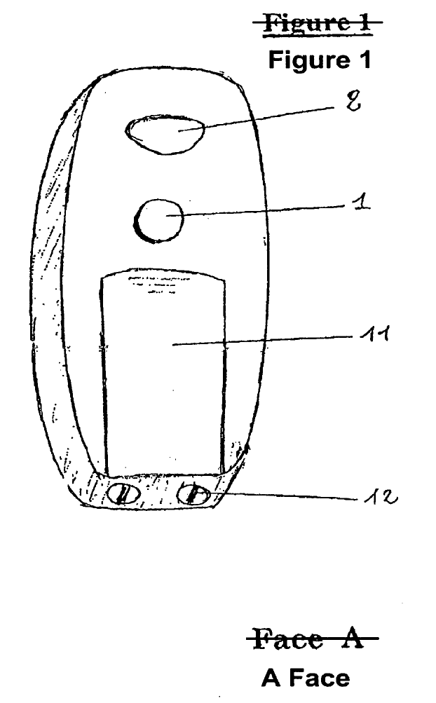

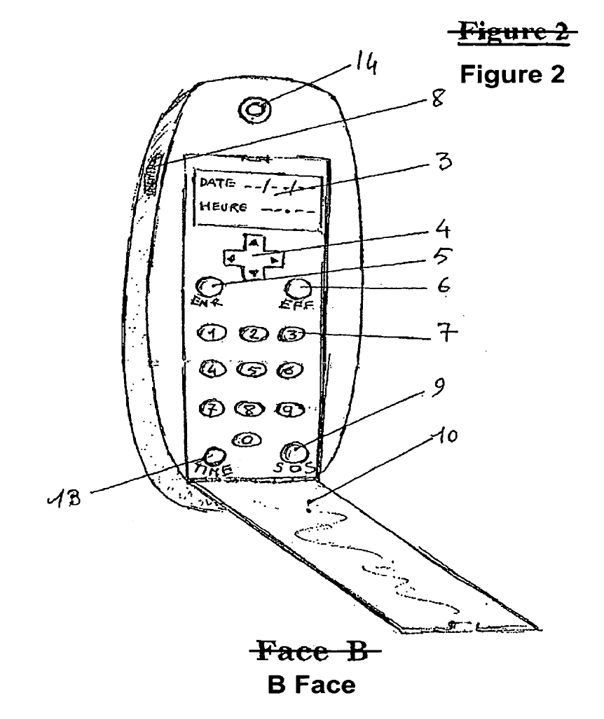

The present invention concerns a portable, lightweight device for receiving pre-recorded messages at programmed times.

1) In its simple version it concerns an “engagement book that speaks”: it concerns a casing the size of a small portable telephone having two faces:

On the A face is a simple push-button (1) and a loudspeaker (2). When the latter emits an alarm, the person need only push the button in order hear said what she must then do (for example: “you have an appointment in half an hour with the director of personnel,” or “do not forget your daughter's birthday. Her number is 01 23 45 67 89.”) The person can re-push the button in order to hear the message repeated, if she did not understand it very well. Each message heard erases the preceding. This face has moreover an access door to the cells (or to the battery in a different option) (11).

The B face is not accessible except by opening the door (10) that hides it. It include a microphone (14), a screen (3) indicating the date and time, programmable by means of displacement keys (4) and numeric information (7). For example, 12.03.02 for the date (12 Mar. 2002) and 11.15 for the time (11 and a quarter hours). Correction is possible, either for an item by pressing briefly on Erase (6), or for the entire line (date or time) by pressing longer.

The date the time being fixed, there remains only to record the message and press the key 5, with the possibility to erase to correct it with the key 6. The internal clock of the apparatus will then enable activation, at the desired time, of the alarm that will enable hearing of the message. Setting or resetting the date and time is effected by pressing the key “time” (13).

A lateral knurled wheel (8) enables regulation of the sound volume. This B face is programmable by its owner or by a third person (a secretary, a member of the family . . . )
2) In its complete version, the apparatus further includes a telephonic receiver permitting programming of it remotely. It is for example indicated for persons having deficient memory to remind them, at the appropriate moment, what they should then do. For example, “Madame, it is time to take your blue pill” or “Mamie get ready, I'm coming to pick you up in half an hour.”

A certain key (9) is here designated to give, in case of a problem, aid indications to a third person. (“My name is Madame X . . . , I live at Y . . . , in case of a problem, inform my son reachable at Z . . . etc. . . . ).

This programmable B face can be employed by any person taking care of the memory deficient owner: her family, her caretakers, etc. But it can also be employed by the person herself who can prove herself capable of making her own program if she knows that she risks forgetting. (For example, an appointment that he just made by telephone at the hairdresser). One could also provide more simple direct programming, vocal.

This apparatus must be programmable remotely by telephonic channel with access code means in order to determine, by family agreement for example, the only persons able to record the messages.

In the case where one chooses the option ‘battery’ rather than “cell”, the apparatus is rechargeable on a base plugged into the electricity. (12: recharge contacts).

According to the invention, a portable recording apparatus includes means permitting to be informed, at programmed days and times, of the reception of messages recorded beforehand. It includes a recorder and an internal clock activating the delivery of messages at desired dated and times.

Such an apparatus is principally characterized in that it also includes a push button on its A face for activating the playing of the recording by the loudspeaker. The apparatus has on its B face a microphone and a hinged access door, notably with a screen for dates and times, keys for programming, a key for recording messages, a key for erasing, a key for setting the date and time, and a possible SOS key.

The apparatus preferably includes a telephone receptor permitting programming remotely by means of a telephone with an access code.

The apparatus preferably has an SOS key, activating playing of basic information about its owner and the persons to inform in case of accident.

The apparatus preferably operates on cells or battery, the access door of which is situated on the A face.

The apparatus preferably has a knurled wheel on the side for regulating the sound intensity of the loudspeaker.

1. A portable recording apparatus including means enabling to be informed at programmed days and times of the reception of messages previously recorded, this apparatus including a recorder and an internal clock activating delivery of messages at desired dates and times, characterized in that it includes a housing having two faces, of which an A face including a press button M and a loudspeaker so that when the latter emits an alarm, the person with a deficient memory can press on the press button in order to hear what she should then do, and a B face that is only accessible by opening a shutter that covers it, this B face including a microphone, a screen indicating the date and time, programmable by means of displacement keys and coded information for, the date and time being fixed, recording the message by pressing on a key, the internal clock of the apparatus enabling the activation at the desired time the alarm that will permit hearing of the message.

2. The apparatus according to claim 1, characterized in that it comprises a telephonic receiver enabling programming remotely by means of a telephone with an access code.

3. The apparatus according to claim 1, characterized in that it has an SOS key activating playing of basic information about its owner and the persons to inform in case of accident.

4. The apparatus according to claim 1, characterized in that it operates on cells and/or on battery, the access door of which is situated on the A face.

5. The apparatus according to claim 1, characterized in that it has laterally a knurled wheel for regulation of the intensity of sound of the loudspeaker.

6. A method for operating with a portable apparatus having a button, and a speaker, the method comprising:
storing a voice message in the apparatus;
storing a date and time in the apparatus, and associating the date and time with the voice message;
running a clock in the apparatus;
responsive to the clock, emitting an audio signal at the date and time stored in the storing step; and
responsive to the button, sending the voice message to the speaker.

7. The method of claim 6 wherein the apparatus further includes a microphone, and the step of storing a voice message includes using the microphone.

8. The method of claim 6 wherein the apparatus further includes a screen indicating the date and time, and keys, and the step of storing a date and time includes using the keys.

9. The method of claim 6 wherein the apparatus further includes a screen indicating the date and time, keys, and a microphone, and the step of storing a date and time includes using the keys; and
the step of storing a voice message includes using the microphone.

10. The method of claim 6 wherein the apparatus further includes a telephonic receiver, and the step of storing a storing a date and time includes using the telephonic receiver.

11. A portable apparatus comprising:
a button;
a speaker; the
means for storing a voice message in the apparatus;
means for storing a date and time in the apparatus, and associating the date and time with the voice message;
a clock in the apparatus;
means, responsive to the clock, for emitting an audio signal at the date and time stored by the storing means; and
means, responsive to the button, for sending the voice message to the speaker.

12. The apparatus of claim 11 further including a microphone, wherein the means for storing a voice message uses the microphone.

13. The apparatus of claim 11 further including a screen indicating the date and time, and keys, wherein the means for storing a date and time uses the keys.

14. The apparatus of claim 11 further including a screen indicating the date and time, keys, and a microphone, wherein
the means for storing a date and time uses the keys; and
the means for storing a voice message uses the microphone.

15. The apparatus of claim 11 further including a telephonic receiver, wherein the means for storing a storing a date and time uses the telephonic receiver.
